(19) United States
(12) Patent Application Publication
(10) Pub. No.: US 2026/0171064 A1
(43) Pub. Date: Jun. 18, 2026

(54) NOISE CONTROLLER, IMAGE FORMING APPARATUS, AND NOISE CONTROL SYSTEM

(71) Applicant: Shinya SHIMIZU, Kanagawa (JP)

(72) Inventor: Shinya SHIMIZU, Kanagawa (JP)

(73) Assignee: ETRIA Co., Ltd., Kanagawa (JP)

(21) Appl. No.: 19/411,857

(22) Filed: Dec. 8, 2025

(30) Foreign Application Priority Data
Dec. 16, 2024 (JP) 2024-220313

(51) Int. Cl. G10K 11/178

(52) U.S. Cl. CPC G10K 11/17823; G10K 11/17825; G10K 11/17883; G10K 2210/1052; G10K 2210/3026; G10K 2210/3027; G10K 2210/3035; G10K 2210/3038

(57) ABSTRACT

A noise controller includes circuitry to predict noise caused by an image forming apparatus in operation based on an operation condition of the image forming apparatus, using a noise prediction program generated by machine learning with multiple pieces of learning data, and generate an antiphase waveform that is reverse in phase to the predicted noise; and a speaker to output a sound wave having the antiphase waveform.

### CROSS-REFERENCE TO RELATED APPLICATIONS

This patent application is based on and claims priority pursuant to 35 U.S.C. § 119(a) to Japanese Patent Application No. 2024-220313, filed on Dec. 16, 2024, in the Japan Patent Office, the entire disclosure of which is hereby incorporated by reference herein.

### BACKGROUND

### Technical Field

The present disclosure relates to a noise controller, an image forming apparatus, and a noise control system.

### Related Art

A noise controller includes a noise prediction means for predicting noise generated by an image forming apparatus based on the operation conditions of the image forming apparatus, and an antiphase waveform generation means for generating an antiphase waveform that is reverse in phase to the noise predicted by the noise prediction means.

A related-art noise controller predicts the noise generated by the driver of an image forming apparatus. Specifically, the noise controller includes drive noise characteristic storage means that stores a data table in which each drive control command for controlling the driver is associated with the predicted noise of the driver operating according to the drive control command. Based on the drive control command, the noise controller determines the predicted noise of the driver, referring to the data table in the drive noise characteristic storage means, thereby predicting the noise generated by the driver. Based on the predicted noise of the driver, the noise controller outputs sound waves having the phase reverse to the phase of the predicted noise to reduce the noise of the driver.

The noise caused by the image forming apparatus in operation becomes louder as various sounds, such as the noise of the driver, the noise of sheet conveyance, and the noise of rotation of the fan, overlap each other.

### SUMMARY

The present disclosure described herein provides a noise controller including circuitry to predict noise caused by an image forming apparatus in operation based on an operation condition of the image forming apparatus, using a noise prediction program generated by machine learning with multiple pieces of learning data, and generate an antiphase waveform that is reverse in phase to the predicted noise. The noise controller further includes a speaker to output a sound wave having the antiphase waveform.

The present disclosure described herein provides an image forming apparatus including an image forming device to form an image on a sheet, and the noise controller described above.

The present disclosure described herein provides a noise control system including an image forming apparatus including first circuitry, and a speaker; and a server including second circuitry. The first circuitry being to transmit an operation condition of the image forming apparatus to the server, the second circuitry being to predict noise caused by the image forming apparatus in operation based on the operation condition of the image forming apparatus, using a noise prediction program generated by machine learning with learning data, and transmit predicted noise data to the image forming apparatus, and the first circuitry being to generate an antiphase waveform that is reverse in phase to the predicted noise data, wherein the speaker outputs a sound wave having the antiphase waveform.

The present disclosure described herein provides a noise control system including an image forming apparatus including first circuitry, and a speaker, a server including second circuitry. The first circuitry transmits an operation condition of the image forming apparatus to the server. The second circuitry predicts noise caused by the image forming apparatus in operation based on the operation condition of the image forming apparatus, using a noise prediction program generated by machine learning with learning data, and transmits predicted noise data to the image forming apparatus. The first circuitry generates an antiphase waveform that is reverse in phase to the predicted noise data, and the speaker outputs a sound wave having the antiphase waveform.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a functional block diagram of a noise control system applied to an image forming apparatus;

FIG. 2 is a schematic diagram illustrating a configuration of an image forming apparatus;

FIG. 3 is a block diagram illustrating a hardware configuration of an image forming apparatus;

FIG. 4 is a block diagram illustrating a hardware configuration of a machine learning server;

FIG. 5 is a block diagram illustrating a functional configuration of a noise control system;

FIG. 6 is a schematic view of an image forming apparatus including a data collecting and providing unit, a machine learning unit, and a learning data generation unit;

FIG. 7 is a block diagram illustrating a functional configuration of an image forming apparatus;

FIG. 8 is a conceptual diagram of an input-output structure that uses a learning model in the machine learning unit;

FIG. 9 is a diagram illustrating machine learning in a machine learning unit;

FIG. 10 is a diagram illustrating the control of noise caused by an image forming apparatus in operation;

FIG. 11 is a flowchart of noise control; and

FIG. 12 is a schematic diagram of a noise control system in which an inference processing unit resides outside an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An application of aspects of the present disclosure to an image forming apparatus is described below.

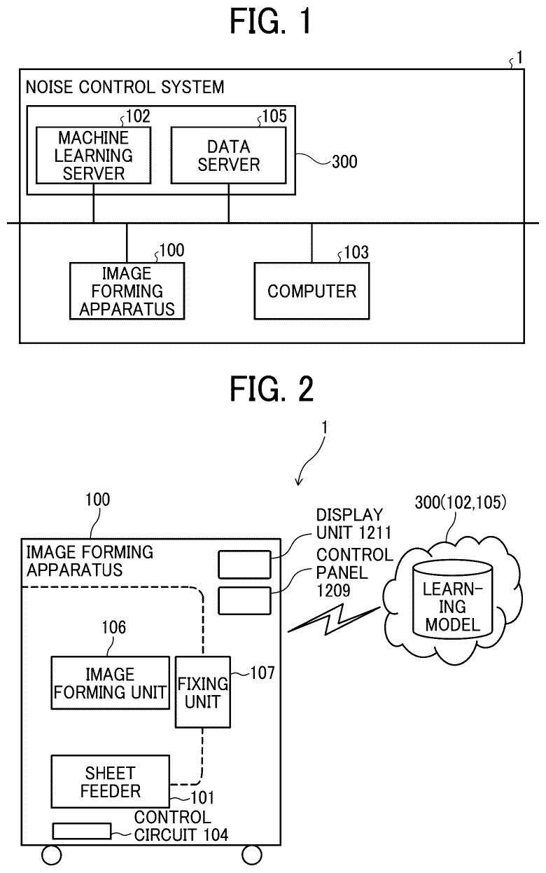

FIG. 1 is a block diagram illustrating a functional configuration of a noise control system 1 applied to an image forming apparatus.

The noise control system 1 includes an image forming apparatus 100 such as a printer, multifunction peripheral, or facsimile machine, external apparatuses 300 (a machine learning server 102 and a data server 105), and a computer 103 that transmits print data to the image forming apparatus 100. The computer is a general-purpose computer. These devices are connected to a network, such as a local area network (LAN). The network may be wired or wireless, and the machine learning server 102 and the data server 105 may communicate with the image forming apparatus 100 via the network, such as the Internet.

FIG. 2 is a schematic diagram illustrating a configuration of an image forming apparatus 100.

The image forming apparatus 100 includes a sheet feeder 101, an image forming unit 106 (image forming device) that forms an image on a recording sheet, and a control circuit 104. The sheet feeder 101 includes a recording sheet tray that accommodates a recording sheet serving as a recording medium on which an image is formed. When the image forming apparatus 100 is a copier, for example, a scanner is disposed above the body of the image forming apparatus.

The image forming unit 106 includes an exposure device as an exposure means, multiple photoconductor drums, a developing device using four color toners of cyan (C), magenta (M), yellow (Y), and black (K), a transfer belt as an intermediate transferor, and a secondary transfer unit. The image forming unit 106 forms an image based on the print data transmitted from, for example, the computer 103 (see FIG. 1). An example of the image forming method is described below. The image forming unit 106 exposes, with the exposure device, the photoconductor drums with light to form electrostatic latent images of respective colors on the photoconductor drums based on the print data, and supplies, with developing units of the developing device, respective color toners onto the latent images on the photoconductor drums, to develop the latent images. The image forming unit 106 then primarily transfers the respective color toner images from the photoconductor drums to the transfer belt, and secondarily transfers, with the secondary transfer unit, the toner images onto the recording sheet as a recording medium to be superimposed with one another. The toner images secondarily transferred and onto the recording sheet and superimposed thereon are fixed on the recording sheet by a fixing unit 107 with heat and pressure. Thus, a color image is formed. The recording sheet on which the image is formed is ejected onto an output tray.

Instead of the electrophotographic image forming unit as described above, an image forming unit employing another recording method, such as an inkjet method, may be used.

The image forming apparatus 100 has an artificial intelligence (AI) function as described above and a noise control function. Using the AI function, the noise control function predicts the noise caused by the image forming apparatus 100 in operation (during the image formation), generates a waveform having a phase reverse to the predicted noise, and reduces the noise during the image formation.

To implement this AI functionality, a learned model that serves as a noise prediction program is generated using the machine learning server 102, as illustrated in FIG. 1. The data server 105 collects learning data (training data) for machine learning by the machine learning server 102 from an external apparatus, such as the image forming apparatus 100, and provides the machine learning server 102 with the learning data.

The image forming apparatus 100 receives a learned model generated by the machine learning server 102 at any desired time and implements a specific AI function using the learned model. The machine learning server 102 illustrated in FIG. 1 receives the learning data for training the learning model to achieve a specific AI function from external sources, such as the data server 105, the image forming apparatus 100, and the computer 103. The machine learning server 102 generates a learned model by performing the learning using some of or the entire learning data.

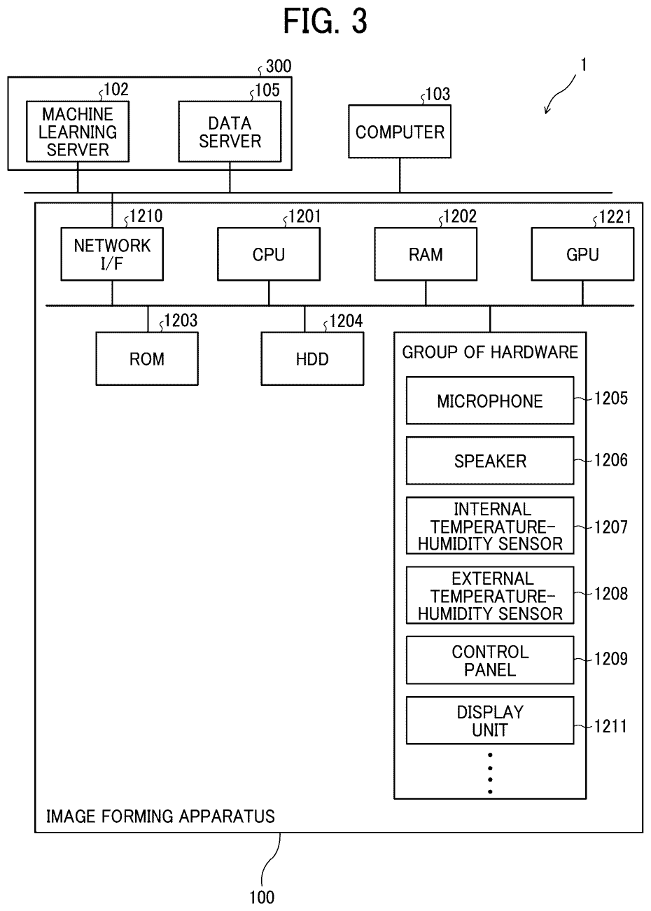

FIG. 3 is a block diagram illustrating a hardware configuration of the image forming apparatus 100.

The image forming apparatus 100 includes a central processing unit (CPU) 1201, a random-access memory (RAM) 1202, and a read-only memory (ROM) 1203. The image forming apparatus 100 further includes a group of hardware including a hard disk drive (HDD) 1204 as a memory (storage unit), a graphics processing unit (GPU) 1221, a network interface (I/F) 1210 as a transmission and reception unit (interface circuit), various types of sensors, and other hardware elements having various functionalities.

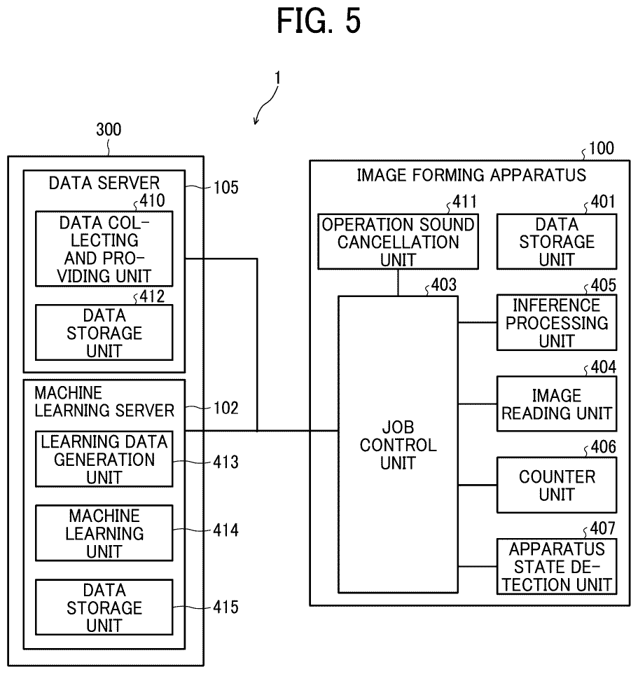

The group of hardware includes a speaker 1206 as a sound wave output device to output sound waves generated based on the set values of the antiphase waveform of the predicted noise provided by an operation sound cancellation unit 411 (see FIG. 5), which will be described later. The group of hardware further includes a microphone 1205 as a sound collector to collect the overlapped sounds in which the noise caused by the image forming apparatus 100 in operation is overlapped with the sound waves output from the speaker 1206. The group of hardware includes an internal temperature-humidity sensor 1207 to measure the temperature and humidity inside the apparatus in operation, an external temperature-humidity sensor 1208 to measure the temperature and humidity outside the apparatus in operation, a display unit 1211, and a control panel 1209. The display unit 1211 includes a liquid crystal display and an input/output device. The control panel 1209 includes a multi-touch sensor.

The sound signal collected by the microphone 1205 is converted into digital data by, for example, an analog-to-digital (A/D) converter and stored in the HDD 1204 as the learning data. The speaker 1206 outputs sound waves that are in reverse phase to the predicted noise by an inference processing unit 405, which is described later. The temperature and the humidity measured by the internal temperature-humidity sensor 1207 and the external temperature-humidity sensor 1208 are stored in the HDD 1204 as learning data by an apparatus state detection unit 407 (see FIG. 5) described later. Additionally, the sheet information, such as the size, the thickness, and the type, of the recording sheet to be conveyed, obtained from the control panel 1209 and the computer 103, and the print mode (print setting), are also stored as learning data in the HDD 1204. Additionally, the temperature and humidity measured by the internal temperature-humidity sensor 1207 and the external temperature-humidity sensor 1208; the sheet information, such as the size, the thickness, and the type of the recording sheet to be fed; and the print mode are also used as input data for the inference processing unit 405 to output the predicted noise, as described later.

The CPU 1201 is a controller that controls the overall operation of the image forming apparatus 100. The RAM 1202 is a system work memory for the CPU 1201 to perform operations, and also serves as an image memory for temporarily storing data such as image data. The network I/F 1210 is connected to the network (e.g., LAN) and performs communication (transmission and reception) with the computer 103, other client computers on the LAN, and the external apparatuses 300, such as the machine learning server 102 and the data server 105. The network I/F 1210 has a wireless communication function for, for example, data communication with an external facsimile machine and wireless communication with an external communication terminal.

The ROM 1203 stores data such as the programs to be executed by the CPU 1201. The HDD 1204 stores data such as system software, image data, and software counter values. Instead of or in addition to the HDD, another type of storage device, such as a solid-state drive (SSD), may be used.

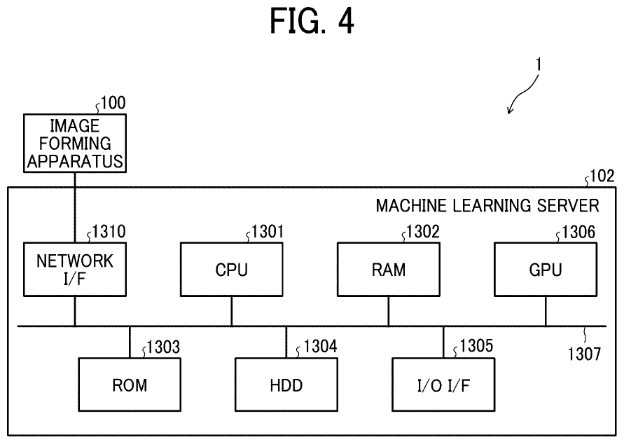

The GPU 1221 processes a large amount of data in parallel to achieve efficient computing. The GPU 1221 may be used in the processing by the inference processing unit 405 (illustrated in FIG. 4) that predicts the noise caused by the image forming apparatus 100 in operation, which is described later. Alternatively, the calculations for the processing of the inference processing unit 405 described later may be performed by either the CPU 1201 or the GPU 1221.

FIG. 4 is a diagram illustrating a hardware configuration of the machine learning server 102.

The machine learning server 102 includes a CPU 1301, a RAM 1302, a ROM 1303, an HDD 1304, a network I/F 1310 as a transmission and reception unit, an input and output (I/O) interface 1305, and a GPU 1306, each of which is interconnected by a system bus 1307.

The CPU 1301 reads out programs such as an operating system (OS) and application software from the HDD 1304 and executes the programs to provide various functions. The RAM 1302 is the system work memory for the CPU 1301 to execute the programs. The ROM 1303 stores programs for activating, for example, a basic input/output system (BIOS) and the OS, and setting files.

The HDD 1304 stores data such as system software. Instead of or in addition to the HDD, another type of storage device, such as an SSD, may be used. The network I/F 1310 is connected to the network and performs communication (transmission and reception) with external apparatuses, such as the image forming apparatus 100.

The I/O interface 1305 is an interface for inputting and outputting information from and to a control panel, which may be an input/output device including a liquid crystal display and a multi-touch sensor. On the control panel, information is drawn at a predetermined resolution and in colors specified by the screen information generated by the program.

For example, a graphical user interface (GUI) screen is drawn, and various windows and data for operation are displayed on the control panel. The control panel may not be included.

Since the GPU 1306 efficiently performs calculations by processing a large amount of data in parallel, the use of the GPU 1306 is effective for conducting machine learning multiple times using learning models such as deep learning. The GPU 1306 is used in addition to the CPU 1301 in the processing by the machine learning unit 414 (see FIG. 5), which will be described later. Specifically, when a learning program including a learning model is executed, the CPU 1301 and the GPU 1306 collaborate in computing for learning. Alternatively, the calculations for the processing of the machine learning unit 414 (see FIG. 5), which will be described later, may be performed by either the CPU 1301 or the GPU 1306.

The data server 105 and the computer 103 can be implemented by a hardware configuration similar to that of the aforementioned machine learning server 102. The data server 105 may not include a control panel, similar to the machine learning server 102. The machine learning server 102 and the data server 105 may be implemented on the same computer.

Each of the machine learning server 102 and the data server 105 may be implemented by a single computer or multiple computers. For example, the machine learning server 102 and the data server 105 may be implemented by cloud computing technologies.

FIG. 5 is a diagram illustrating a functional configuration of the noise control system 1.

The functional configuration of the noise control system 1 illustrated in FIG. 5 is implemented by the hardware resources and programs as indicated in FIGS. 1, 3, and 4. The programs to implement the functional configuration illustrated in FIG. 4 are stored in the storage device for each component, read into the RAM, and implemented by the CPU.

For example, in the image forming apparatus 100, the programs for implementing the functional configuration illustrated in FIG. 5 are stored in the HDD 1204, read into the RAM 1202, and executed by the CPU 1201. The GPU 1221 may be used in addition to the CPU 1201.

In the machine learning server 102, the programs to implement the functional configuration illustrated in FIG. 4 are stored in the HDD 1304, read into the RAM 1302, and executed by the CPU 1301. The GPU 1306 may be used in addition to the CPU 1301. In the data server 105, the programs to implement the functional configuration illustrated in FIG. 4 are stored in the HDD 1304, read into the RAM 1302, and executed by the CPU 1301.

The functional configuration illustrated in FIG. 5 is for predicting the noise caused by the image forming apparatus in operation and generating the antiphase waveform of the predicted noise, using a learned model that is a noise prediction program trained using learning data. This is the functional configuration of the noise control system 1 that provides the function to output the generated antiphase waveform from the speaker 1206 (see FIG. 2) while the apparatus is in operation, thereby reducing the noise during the operation.

As illustrated in FIG. 5, the functional configuration of the image forming apparatus 100 includes a data storage unit 401 as a storage unit to store learning data, a job control unit 403, the operation sound cancellation unit 411 as an antiphase waveform generation unit, and the inference processing unit 405 as a noise prediction unit. The functional configuration further includes an image reading unit 404, a counter unit 406, and an apparatus state detection unit 407. In the case that the image forming apparatus 100 does not include a scanner, the image reading unit 404 is unnecessary. The job control unit 403, the operation sound cancellation unit 411 as the antiphase waveform generation unit, and the inference processing unit 405 as the noise prediction unit are held as a part of the control program written in the control circuit 104 (see FIG. 2).

The job control unit 403 implements basic functions, such as copying, faxing, and printing, of the image forming apparatus 100 based on user instructions, and performs the transmission and reception of instructions or data to and from other software components, accompanying the implementation of the basic functions.

The apparatus state detection unit 407 detects the state of the image forming apparatus 100 (may be referred to as an “apparatus state”), for example, when a print job is received. The state of the image forming apparatus 100 is, for example, the temperatures and the humidity inside and outside the image forming apparatus 100 obtained by the internal temperature-humidity sensor 1207 and the external temperature-humidity sensor 1208. The detected apparatus state is stored in the data storage unit 412 as learning data or used as the input data for the inference processing unit 405.

The data storage unit 401 stores image data (print data), learning data described later, learned models, and other data in the RAM 1202 and HDD 1204 in the hardware configuration illustrated in FIG. 3.

The learning data stored in the data storage unit 401 includes:
the input data input to the inference processing unit 405;
the predicted noise data predicted by the inference processing unit 405; and
noise data (overlapped sounds) collected by the microphone 1205 during the image forming operation while the speaker 1206 outputs antiphase sound waves.

The input data to the inference processing unit 405 indicates the apparatus operation conditions related to changes in noise generated during a print operation. The input data is obtained by, for example, the apparatus state detection unit 407 when a print job is received.

The input data includes:
print mode (copy/print, monochrome/color, feed tray), sheet feeding speed (normal/fast/slow), etc.,
temperature and humidity outside the apparatus and inside the apparatus, and
information on a sheet to be fed, such as sheet type, sheet thickness, and size. The input data is not limited to the above-described items.

The noise data collected by the microphone 1205 during the image forming operation is converted into digital data by the A/D converter and stored in the data storage unit 401.

The learning data is stored in the data storage unit 401 in a data table. The data table includes the input data input to the inference processing unit 405, the predicted noise data predicted by the inference processing unit 405 from the input data, and overlapped sound data collected by the microphone 1205, which are associated with each other. In the overlapped sound data, the sound waves output from the speaker 1206 are overlapped with noise. The learning data stored in the data storage unit 401 is transmitted to the data server 105 at a predetermined timing or in response to a request from the data server 105. In the description below, each time learning data is obtained, the learning data is transmitted to the data server 105.

The inference processing unit 405 predicts the noise caused by the image forming apparatus 100 in operation based on the input data, using the learned model that is a noise prediction program generated by the machine learning server 102 by machine learning.

The noise generated during the operation of the image forming apparatus (print operation) includes:
rotational noise from rotators such as motors, fans, and rollers;
mechanical operation sound during image formation (the drive sound of a motor, gear, etc., and sliding sound);
mechanical sound of sheet conveyance (the sound of the conveyance motor, the feed motor, and gear operation, etc.); and
rubbing sound between the feed roller and the sheet feeding guide.

The inference processing unit 405 predicts the noise in the operation (print operation) in which these sounds overlap, based on the aforementioned input data (print mode, temperature and humidity outside and inside the apparatus, and sheet information). The prediction of the noise is performed based on an instruction from the job control unit 403. The inference processing unit 405 is implemented by, for example, the CPU 1201 and the GPU 1221 illustrated in FIG. 2.

The result predicted by the inference processing unit 405 is transmitted via the job control unit 403 to the operation sound cancellation unit 411. The operation sound cancellation unit 411 reflects the result in the set value of the antiphase sound wave. Then, the antiphase sound wave is generated from the reflected set value and output from the speaker 1206, thereby reducing or muting the noise during the operation.

The result predicted by the inference processing unit 405 is transmitted to the job control unit 403 to let the user recognize that sound is being output from the speaker 1206. For example, a notification message is displayed on the control panel 1209. Additionally, based on the display of the notification message, the user may be prompted to input the feedback about the noise control, such as the sound output from speaker 1206 being too loud, and the volume of the speaker 1206 may be adjusted based on the feedback.

The image reading unit 404 reads the document with the reader according to the instructions of the job control unit 403 for controlling copying or scanning, and optically reads the recording sheet with the in-line sensor in the apparatus.

The counter unit 406 records various counter values (for example, total printed pages) in the image forming apparatus 100.

The functional configuration of the data server 105 includes a data collecting and providing unit 410 and a data storage unit 412.

The data collecting and providing unit 410 collects and provides the learning data for the machine learning server 102. The data collecting and providing unit 410 collects the learning data from multiple image forming apparatuses 100 and provides the learning data to the machine learning server 102.

The data collecting and providing unit 410 may be configured to receive learning data from multiple image forming apparatuses 100 connected to the network, such as a LAN, at any time, and to transmit the collected learning data to the machine learning server 102 in response to a request from the machine learning server 102. This allows the learning model of the machine learning unit 414 to perform machine learning using the learning data of the image forming apparatus to which the machine learning unit 414 belongs and the learning data collected from other image forming apparatuses by the data collecting and providing unit 410. This allows the learning model to learn a large amount of learning data, which can enhance the accuracy of the learned model.

The data storage unit 412 records the learning data collected by the data collecting and providing unit 410. The functional role of each software component of the data server 105 is implemented by the CPU and other components of the data server 105.

The functional configuration of the machine learning server 102 includes a learning data generation unit 413, a machine learning unit 414, and a data storage unit 415.

The learning data generation unit 413 optimizes the received learning data to achieve the desired learning effect. For example, the learning data generation unit 413 removes unnecessary data that causes noise from the learning data received from the data server 105 and adjusts the format of the learning data for input into the learning model to optimize the learning data. Further, the learning data generation unit 413 combines the predicted noise data included in the learning data with the sound collected by the microphone 1205 (the noise caused by the image forming apparatus in operation and the sound waves output from the speaker 1206) to generate correct noise data. The learning data optimized by the data generation unit 413 is transmitted to the machine learning unit 414.

The data storage unit 415 temporarily records the learning data received from the data server 105, the learning data optimized by the data generation unit 413, and the learning model in the machine learning unit 414 in the RAM 1302 and the HDD 1304 illustrated in FIG. 3.

The functional roles of the learning data generation unit 413 and the data storage unit 415 are implemented by, for example, the CPU 1301 illustrated in FIG. 3.

The machine learning unit 414 performs machine learning with learning data (training data) optimized by the learning data generation unit 413 to achieve the desired learning effect, using the hardware resources (such as the GPU 1306 and the CPU 1301) illustrated in FIG. 3 and the learning method by the learning model.

In the description above, the data server 105 and the machine learning server 102 that generate the learning model are external to the image forming apparatus. Alternatively, the image forming apparatus may have the functions of the data server 105 and the machine learning server 102 as described below.

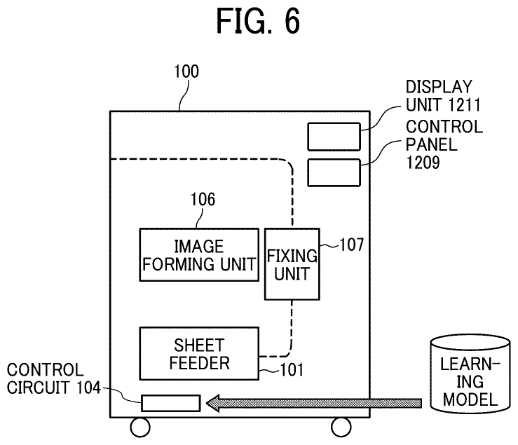

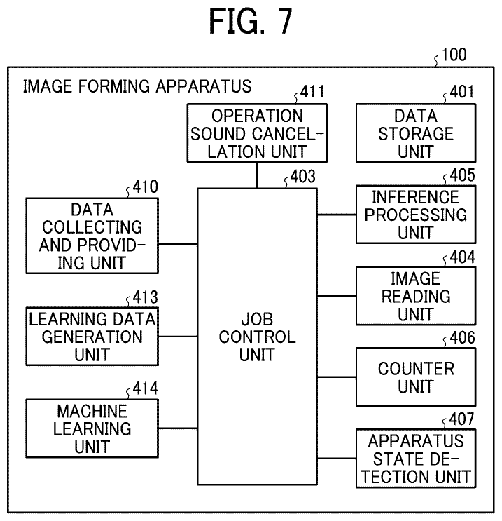

FIG. 6 is a schematic diagram of the image forming apparatus 100 provided with the functions of the data server 105 and the machine learning server 102. FIG. 7 is a block diagram illustrating a software configuration of the image forming apparatus 100 including the data collecting and providing unit, the learning unit, and the learning data generation unit.

The functions of the data server 105 and the machine learning server 102 are held as a part of the control programs written in the control circuit 104.

As illustrated in FIG. 7, the image forming apparatus 100 includes the data collecting and providing unit 410 that collects learning data, and the machine learning unit 414 that generates a learned model. The image forming apparatus 100 further includes the data generation unit 413 that optimizes the learning data provided to the machine learning unit 414. The data collecting and providing unit 410 collects learning data also from image forming apparatuses of the same model and the data server 105 via a network as needed. The multiple pieces of learning data collected from the image forming apparatus to which the data collecting and providing unit 410 belongs and from other image forming apparatuses are used in the machine learning by the learning model of the machine learning unit 414. This allows the learning model to learn a large amount of learning data, which can enhance the accuracy of the learned model.

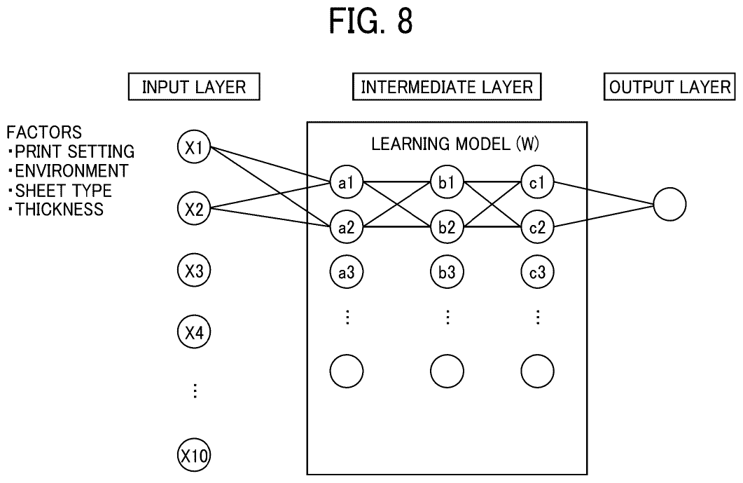

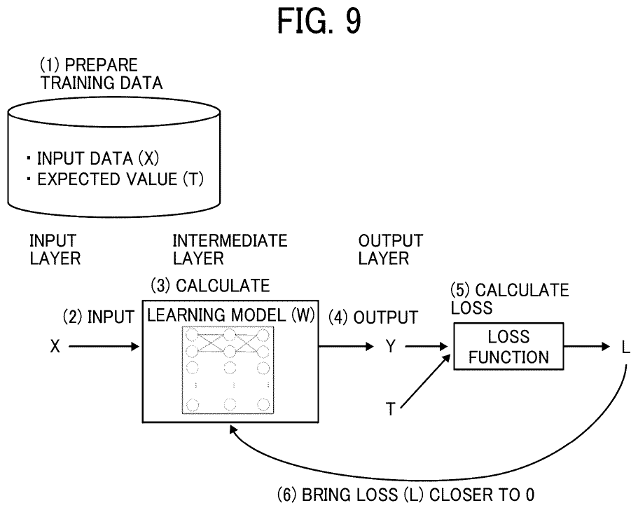

FIG. 8 is a conceptual diagram of an input-output structure using a learning model in the machine learning unit 414. FIG. 9 is a diagram illustrating the machine learning by the machine learning unit 414. In FIG. 9, a learning model using a neural network is illustrated.

The features of the noise control system 1 are described below. In this example, the elements (input layer) X of the learning data for a learning model W that predicts (outputs) the noise generated by the apparatus in operation using apparatus information as input through the neural network are denoted as X1 to X10. The input layer illustrated in FIG. 8 is the input data mentioned above.

As specific algorithms of machine learning, examples include nearest neighbors, naive Bayes, decision trees, and support vector machines, in addition to neural networks. Another example is deep learning, which uses a neural network to generate a feature value and a connection weight for learning. Any available one can be selected from the above-mentioned algorithms.

The learned models may include an error detection unit and an updating unit.

The machine learning unit 414 uses the learning data optimized by the learning data generation unit 413 as training data. The input data of the training data (data input to the inference processing unit 405) is set as an element (input layer) X of the learning data. In addition, correct noise data, which is obtained by combining the predicted noise data included in the learning data with the overlapped sound data (in which the noise in the operation and the sound output from the speaker 1206 are overlapped) collected by the microphone 1205, is used as an expected value T.

In the error detection, an error between output data (predicted noise data) Y, which is calculated by the neural network in accordance with the input data X input to the input layer and output from the output layer, and the expected value (correct noise data) T is calculated, and a loss L representing the error is calculated using a loss function. Based on the loss L, parameters such as the connection weight between the nodes of the neural network are updated such that the loss L is reduced (the loss L is brought closer to 0).

In this updating, for example, error backpropagation is used to update the parameters such as the connection weight between the nodes of the neural network. Error backpropagation is a method of adjusting, for example, a connection weight between the nodes of each neural network to reduce the error.

In this manner, the weight inside the learning model W is adjusted such that the output data (predicted noise data) Y, which is output when the input data X corresponding to the expected value (correct noise data) T is input to the learning model W, approaches the expected value (correct noise data) T. Thus, the learning model W with high accuracy is obtained. This process is referred to as a learning process, and the learning model adjusted through this learning process is referred to as a “learned model.”

The “learned model” obtained in this manner is transmitted to each image forming apparatus 100 via the network in the noise control system 1, illustrated in FIGS. 1 to 5, in which the machine learning server 102 includes the machine learning unit 414. When each of the image forming apparatuses 100 receives the “learned model” from the machine learning server 102, the “learned model” stored in the HDD 1204 is updated to the received “learned model”. For example, the “learned model” may be received from the machine learning server 102 when the power of the image forming apparatus 100 is turned on.

By contrast, in the configuration in which the image forming apparatus 100 includes the machine learning unit 414 as illustrated in FIGS. 6 and 7, the “learned model” stored in the HDD 1204 of the image forming apparatus is updated. The “learned model” may be updated each time the learning model of the machine learning unit 414 is adjusted, or the “learned model” may be updated when the accuracy of the learning model is increased.

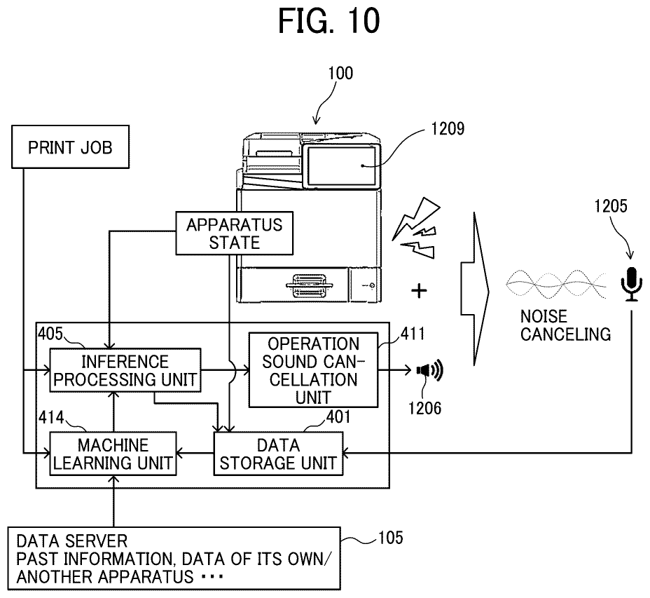

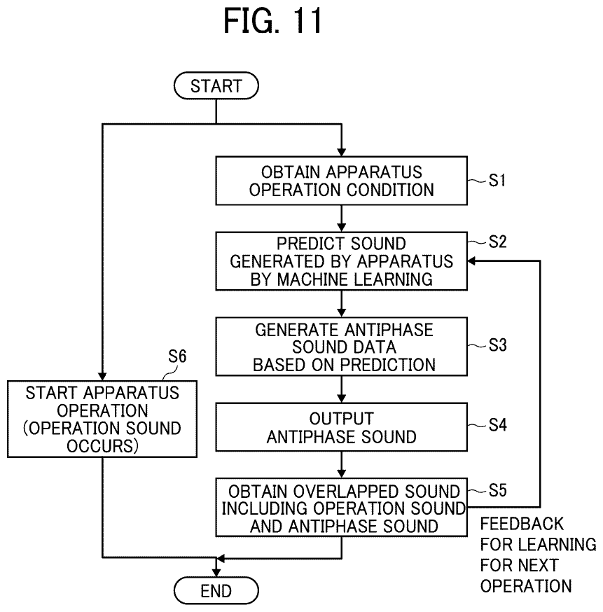

FIG. 10 is a diagram illustrating the control of noise caused by the image forming apparatus 100 in operation. FIG. 11 is a flowchart of the noise control. FIGS. 10 and 11 illustrate a case where the image forming apparatus illustrated in FIGS. 6 and 7 includes the machine learning unit 414. The left side of FIG. 11 illustrates the process for printing, and the right side of FIG. 11 illustrates the process for noise control.

As illustrated in FIG. 10, when a print job is input, in step S1, the apparatus operation conditions to be input to the inference processing unit 405 are obtained. Specifically, as described above, the internal temperature and humidity measured by the internal temperature-humidity sensor 1207 (see FIG. 2), the external temperature and humidity measured by the external temperature-humidity sensor 1208 (see FIG. 3), and the print mode and the sheet type information input to the control panel 1209 are obtained as the apparatus operation conditions input to the inference processing unit 405. The internal temperature and humidity, the external temperature and humidity, the print mode, and the sheet type information obtained as the apparatus operation conditions are stored in the data storage unit 401.

In step S2, the obtained apparatus operation conditions are input to the inference processing unit 405 (learned model), and the inference processing unit 405 (learned model) predicts the noise caused by the apparatus in the print operation by machine learning. In step S3, the predicted noise output by the inference processing unit 405 (trained model) is stored in the data storage unit 401, and the operation sound cancellation unit 411 generates the antiphase sound data of the predicted noise data based on the predicted noise data. In step S4, the antiphase sound data generated by the operation sound cancellation unit 411 is converted into analog signals, and the antiphase sound waves are output from the speaker 1206 simultaneously with the start of print operation by the apparatus.

Thus, the noise caused by the apparatus in operation and the antiphase sound wave generated from the speaker 1206 cancel out, and the noise caused by the apparatus in operation is reduced.

In step S5, simultaneously with the start of the print operation by the apparatus, the microphone 1205 collects the composite sound of the noise caused by the apparatus and the antiphase sound wave output from the speaker 1206. The overlapped sound collected by the microphone 1205 is converted into digital data (overlapped sound data) by the A/D converter. Then, the overlapped sound data is stored in the data storage unit 401 as learning data in association with the apparatus operation condition as input data to the inference processing unit 405 (learned model) and the predicted noise data output from the inference processing unit 405 (learned model). The learning data stored in the data storage unit 401 is transmitted to the machine learning unit 414 and processed into training data. Specifically, the correct noise data as the expected value T is generated based on the overlapped sound data collected by the microphone 1205 and the predicted noise data. The machine learning unit 414 inputs the apparatus operation conditions as input data to the learning model, obtains the error between the predicted noise data output from the learning model and the correct noise data as the expected value T, and calculates a loss representing the error using a loss function. Based on the loss L, the parameters such as the connection weight between the nodes of the neural network are updated such that the loss L is reduced (the loss L is brought closer to 0), to adjust the learning model. The learning model adjusted by the machine learning unit 414 is used as a learned model for predicting noise in the next noise control. Thus, in the next machine operation, the noise caused by the apparatus in operation is predicted with higher accuracy, and noise can be more effectively reduced.

As illustrated in FIG. 10, the machine learning unit 414 performs machine learning of the learning model using the learning data received from the data server 105. This allows a large amount of learning data to be used in training the learning model, and the accuracy of the learning model is enhanced.

As described above, the noise caused by the apparatus in operation includes the rotation sound of a rotator, such as a motor, a fan, or a roller, the drive sound of a motor, a gear, etc., sliding sound, and the rubbing sound between the sheet conveyed and the sheet conveyance path, which are overlapped with one another. The rotation sound is caused by the motor or the fan that operates at a certain constant speed during printing, but other operation sounds, such as the sheet conveyance sound, vary depending on the operation conditions such as the operation mode, the sheet type, and the sheet thickness. All of the above-described sounds generated during the operation of the apparatus vary depending on factors such as the individual differences among the apparatuses, the surrounding environment, and the change with time. Accordingly, the sound cancelling effect may be reduced by the antiphase sound wave prepared in advance.

In contrast, according to one aspect of the present disclosure, the noise caused by the apparatus in operation is predicted using machine learning, and the noise caused by the apparatus in operation is canceled out by the antiphase sound wave of the predicted noise. The use of machine learning for noise control to reduce noise enables the accurate prediction of the noise that varies depending various factors such as individual differences of the apparatuses, the surrounding environment, and changes over time, and more effective noise reduction and effective noise reduction functions are achieved.

The inference processing unit 405 (learned model) may be held in the external apparatus 300 that communicates with the image forming apparatus 100 via the network. The external apparatus 300 may be a cloud system including the machine learning server 102 and the data server 105.

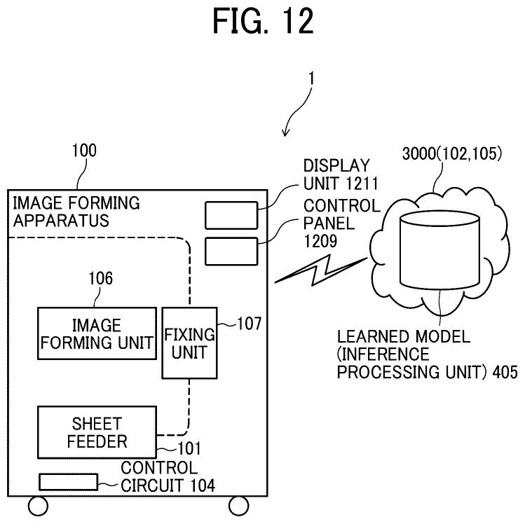

FIG. 12 is a schematic diagram illustrating the noise control system 1 in a configuration in which the inference processing unit 405 (learned model) is included in a cloud system 3000 as an external apparatus outside the image forming apparatus 100.

In the noise control system 1 illustrated in FIG. 12, the apparatus operation conditions of the image forming apparatus 100, such as the internal temperature and humidity, the external temperature and humidity, the print mode, and the sheet type information are transmitted as data to the cloud system 3000 serving as a noise prediction apparatus. The image forming apparatus 100 receives predicted noise data predicted based on the apparatus operation condition received by the inference processing unit 405 (learned model) on the cloud system 3000. Based on the predicted noise data, the operation sound cancellation unit 411 (see FIG. 5) of the image forming apparatus 100 generates antiphase sound data of the predicted noise, and outputs the antiphase sound from the speaker 1206 simultaneously with the start of the print operation by the image forming apparatus 100. With this configuration, even an image forming apparatus without an AI function (learned model) can achieve noise reduction based on the predicted noise. In the configuration in which the image forming apparatus 100 includes the inference processing unit 405 (learned model), the communication between the image forming apparatus 100 and the cloud system 3000 is unnecessary at the timing of printing, and the time from the input of the user's instruction for printing to the control panel 1209 to the start of printing by the image forming apparatus 100 can be shortened.

The above-described embodiments are illustrative and do not limit the embodiments of the present disclosure. Thus, numerous additional modifications and variations are possible in light of the above teachings. For example, elements and/or features of different illustrative embodiments may be combined with each other and/or substituted for each other within the scope of the present disclosure.

The configurations described above are examples, and various aspects of the present disclosure provide, for example, the following effects, respectively.

### Aspect 1

A noise controller includes a noise prediction unit, such as the inference processing unit 405, that predicts noise caused by an image forming apparatus based on an operation condition, such as an operation condition of the image forming apparatus; an antiphase waveform generation unit, such as an operation sound cancellation unit 411, that generates an antiphase waveform having a phase reverse to the noise predicted by the noise prediction unit; and a sound wave output device, such as the speaker 1206, that outputs a sound wave having the antiphase waveform generated by the antiphase waveform generation unit. The noise prediction unit predicts the noise using a noise prediction program, such as a learned model that is trained by machine learning with multiple pieces of learning data.

As described above, the noise caused by the image forming apparatus in operation becomes louder as various sounds, such as the noise of the driver, the noise of sheet conveyance, and the noise of rotation of the fan are overlapped. The operation sounds such as sheet conveyance sound are not constantly generated during the operation, and vary depending on the operation conditions such as the operation mode, the sheet type, and the sheet thickness. All of the above-described sounds vary depending on factors such as the individual differences among the apparatuses, the surrounding environment, and the change with time. The noise reduction effect may be low if the antiphase waveform is generated from the predicted noise stored in the storage unit in advance.

Accordingly, according to Aspect 1, the noise is predicted based on the noise prediction program that has been machine-learned using multiple pieces of learning data. In this way, the use of machine learning for predicting noise can increase the accuracy of prediction of the noise caused by the image forming apparatus in operation although the noise includes various sounds overlapped each other and changes due to various factors. As a result, the noise of the image forming apparatus can be reduced satisfactorily by the antiphase waveform generated based on the predicted noise.

### Aspect 2

In the noise controller according to Aspect 1, the operation condition, such as the operation condition of the image forming apparatus, includes print settings such as a print mode, temperature and humidity during operation (internal temperature and humidity and external temperature and humidity), and the type and the thickness of the sheet to be fed.

According to this, the noise prediction program predicts the noise based on the factors of the noise generated during the operation of the image forming apparatus. The factors include the print settings such as the print mode, the temperature and humidity (the internal temperature and humidity and the external temperature and humidity) during the operation, the type of the sheet to be fed, and the thickness of the sheet. Thus, the noise generated during the operation can be predicted with high accuracy.

### Aspect 3

The noise controller according to aspect 1 or 2 further includes a sound collector, such as the microphone 1205, that collects overlapped sounds including the sound wave having the antiphase waveform output by the sound wave output device, such as the speaker 1206, and the noise caused by the image forming apparatus in operation; and a storage unit, such as the data storage unit 401, that stores the overlapped sound collected by the sound collector, the operation condition of the image forming apparatus, and the predicted noise predicted by the noise prediction unit, such as the inference processing unit 405 as the learning data.

According to this, as described above, machine learning is executed using learning data stored in the storage unit, such as the data storage unit 401, and the accuracy of the learning model can be increased.

### Aspect 4

In the noise controller according to Aspect 3, the noise prediction program, such as the learned model, is obtained by machine learning using pieces of learning data collected from multiple image forming apparatuses.

According to this, as described above, training can be performed using a large amount of learning data, and the accuracy of the learning model can be increased.

### Aspect 5

An image forming apparatus includes the noise controller according to any one of Aspects 1 to 4.

According to this, as described above, the noise caused by the image forming apparatus in operation can be reduced satisfactorily.

### Aspect 6

In the image forming apparatus according to Aspect 5, the image forming apparatus includes a transmission and reception unit, such as the network I/F 1210, that transmits and receives to and from the external apparatus 300, and the transmission and reception unit transmits various types of information obtained from the image forming apparatus to a server, such as the data server 105, included in the external apparatus 300 as learning data, and receives the noise prediction program, such as the learned model, from a server, such as the machine learning server 102, included in the external apparatus 300.

According to this, machine learning can be performed by an external apparatus, and the load on the image forming apparatus can be reduced as compared with the case where the image forming apparatus performs the machine learning.

### Aspect 7

The noise control system 1 includes the image forming apparatus 100 and the external apparatus 300, such as a cloud system including a noise prediction unit (the inference processing unit 405) that predicts noise caused by the image forming apparatus 100 in operation. The image forming apparatus 100 transmits an operation condition in an image forming operation to the noise prediction unit. The noise prediction unit predicts noise caused in image forming operation by a noise prediction program (learned model) that has been machine-learned using multiple pieces of learning data, and transmits predicted noise data to the image forming apparatus 100. The image forming apparatus 100 generates an antiphase waveform having a phase reverse to the phase of the predicted noise based on the predicted noise data and outputs a sound wave having the antiphase waveform.

According to this, even when the image forming apparatus does not have an AI function, the image forming apparatus can use the AI function on the cloud to accurately predict the noise caused by the image forming apparatus in operation that changes due to various factors, generate the antiphase waveform based on the predicted noise, and preferably reduce the noise of the image forming apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A noise controller comprising:
circuitry configured to:
predict noise caused by an image forming apparatus in operation based on an operation condition of the image forming apparatus, using a noise prediction program generated by machine learning with multiple pieces of learning data; and
generate an antiphase waveform that is reverse in phase to the predicted noise; and
a speaker to output a sound wave having the antiphase waveform.

2. The noise controller according to claim 1,
wherein the operation condition includes a print setting, temperature and humidity in the operation of the image forming apparatus, and a type and a thickness of a sheet to be fed.

3. The noise controller according to claim 1, further comprising:
a microphone to collect overlapped sounds including the sound wave having the antiphase waveform output by the speaker and the noise caused by the image forming apparatus in operation; and
a memory that stores the overlapped sounds collected by the microphone, the operation condition, and the predicted noise as the multiple pieces of learning data.

4. The noise controller according to claim 3,
wherein the multiple pieces of learning data include pieces of learning data collected from multiple image forming apparatuses.

5. An image forming apparatus comprising:
an image forming device to form an image on a sheet; and
the noise controller according to claim 1.

6. The image forming apparatus according to claim 5, further comprising
an interface circuit to transmit the multiple pieces of learning data to an external apparatus and receive the noise prediction program generated by the external apparatus from the external apparatus.

7. A noise control system comprising:
an image forming apparatus including:
first circuitry; and
a speaker; and
a server including second circuitry,
the first circuitry being configured to transmit an operation condition of the image forming apparatus to the server,
the second circuitry being configured to:
predict noise caused by the image forming apparatus in operation based on the operation condition of the image forming apparatus, using a noise prediction program generated by machine learning with learning data; and
transmit predicted noise data to the image forming apparatus, and
the first circuitry being configured to generate an antiphase waveform that is reverse in phase to the predicted noise data,
wherein the speaker outputs a sound wave having the antiphase waveform.
